(19) United States
(12) Patent Application Publication
(10) Pub. No.: US 2003/0230524 A1
(43) Pub. Date: Dec. 18, 2003

(54) Chromatographic chip and method of fabrication thereof

(76) Inventors: Naohiro Soga, Kobe (JP); Kazuki Nakanishi, Kyoto (JP); Hiroyoshi Minakuchi, Kyoto (JP)

Correspondence Address: KANESAKA AND TAKEUCHI, 1423 Powhatan Street, Alexandria, VA, 22314, US

(21) Appl. No.: 10/173,538

(22) Filed: Jun. 18, 2002

(51) Int. Cl. B01D 15/08

(52) U.S. Cl. 210/198.2; 422/70; 73/61.52; 438/49

(57) ABSTRACT

A chromatographic chip is formed of a plate member, a plurality of grooves formed on the plate member, and silica gel having monolithic bimodal pore structure formed in at least one of the grooves. The monolithic bimodal pore structure includes through pores and mesopores smaller than those of the through pores.

### BACKGROUND OF THE INVENTION AND RELATED ART STATEMENT

The present invention relates to a chromatographic chip and a method of fabrication thereof. The chromatographic chip of the present invention is used for proteome analysis, and the like.

Electrophoresis and liquid chromatographs have been used from the past when analyzing very minute proteins and amino acids, and the like, and capillary electrophoresis and capillary liquid chromatographs are used. These devices is filled with separation matrices in glass capillaries having 100 μm inner diameter to perform analysis.

Also, in the early 1990s, the possibility of creating miniature versions of analysis devices was discussed, and in D. J. Harrison et al/Anal. Chem. 1993, 283, 361-366, there is proposed an electrophoresis chip which is formed by bonding two substrates.

The electrophoresis chip is formed of a pair of transparent plate-shaped substrates composed of an inorganic material, and by semiconductor photolithographic technology and etching technology or micromachining technology, electrophoresis capillary grooves which intersect each other are formed on the surface of one substrate, and through-holes are provided as reservoirs in positions corresponding to those grooves on the other substrate.

In order to use an electrophoresis chip such as the above as a chromatograph, an inorganic polyporous body such as of silica gel must be filled into the grooves. However, as for the method by particle filling, the filling method is complex and it takes a long time, moreover it is difficult to reproduce the filled state which has excellent separation performance. Furthermore, because uniform filling of microparticles becomes vastly more difficult as the groove length (column length) is increased, it is difficult to improve separation performance by increasing the column length. Also, in the particle filling method, there is a problem that air bubbles often arise in the test sample solution in the space between the frit and the filled layer, and it lowers the separation performance.

Also, the sample introduced into the analysis chip such as the electrophoresis chip of the past is one which was refined by undergoing preprocessing. For example, biological test samples, and the like, are introduced into the analysis chip after foreign bodies were removed by refining in advance by gel filtration method and ethanol precipitation method, and the like. In the gel filtration method and ethanol precipitation method, centrifuging is performed in order to accelerate the processing time and increase the yield of the sample. However, because refining and introduction are separate processes, they take a long time, and in addition, a device for preprocessing also becomes necessary in addition to the analysis chip.

Thus, an object of the present invention is to provide a chromatographic chip which has high reproducibility, low fluid resistance, and high separation performance, by synthesizing a unified (monolithic) polyporous body by liquid phase reaction inside the grooves on the chip in place of the particle filling method.

Another object of the invention is to provide a chromatographic chip as stated above, wherein not only separation channels or grooves, but also sample preparation grooves are formed on the chip, to realize preprocessing and separation on one chip.

Further objects and advantages of the invention will be apparent from the following description of the invention.

### SUMMARY OF THE INVENTION

The chip of the present invention is a chromatographic chip, which is made by forming grooves on a plate member and forming silica gel having monolithic bimodal pore structure in these grooves.

This chip is fabricated by preparing a gel formed of a solvent rich phase which is rich in solvent and is continuous in three-dimensional network form, and a skeletal phase which is rich in inorganic substance and has micropores on the surface, by sol-gel method using phase separation in those grooves, and then drying and heating the wet gel.

Likewise, means for achievement of the above objects is made by dissolving a water-soluble polymer and a thermolytic polymer in an acidic aqueous solution, adding to that a metal compound having a hydrolytic functional group and performing a hydrolysis reaction, and then heating the wet gel after the product has hardened inside the grooves on the plate member so that the low-molecular weight compounds which were dissolved in advance during gel preparation are thermolyzed. Finally, the formed material is dried and heated.

Here, water-soluble polymer theoretically is a water-soluble organic polymer that can create an aqueous solution of adequate concentration, and it may be any one that can be dissolved in a reaction system containing alcohol produced by a metal compound having a hydrolytic functional group, but specifically, sodium salt or potassium salt of polystyrene sulfonate which is polymeric metal salt, polyacrylic acid which is a polymer acid and is dissociated into polyanions, polyallylamine and polyethyleimine which are polymer alkalis and produce polycations, or neutral polymers polyethylene oxide which has an ether bond in the main chain, and polyvinyl pyrrolidone which has a carbonyl group in the main chain, and the like, are optimal. Also, formamide, polyvalent alcohol, and surfactants may be used in place of the organic polymer, and in that case, glycerine is optimal as the polyvalent alcohol, and polyethylene alkoxy ethers are optimal as the surfactants.

As the metal compound having a hydrolytic functional group, a metal alkoxide or oligomer thereof can be used, and these preferably are those which have few carbon atoms, for example methoxy group, ethoxy group, methyl group, vinyl group and propoxy group. Also, as metal, metal oxides which are produced in the end, for example, Si, Ti, Zr, and Al, are used. These metals may be one kind or two or more kinds. on the other hand, the oligomer may be any one that can be uniformly dissolved and dispersed in alcohol, and specifically, up to decamers can be used.

Also, as the acidic aqueous solution, usually one with at least 0.001 mol concentration of mineral acid such as hydrochloric acid and nitric acid, or one with at least 0.01 mol concentration of organic acid such as acetic acid and formic acid, is preferable.

Phase separation and gelling can be achieved by keeping the solution in the grooves on the plate member at 40-80° C. for 0.5-5 hours. Phase separation and gelling undergo a process in which the solution which was at first transparent becomes whitened, phase separation into a silica phase and a water phase occurs, and finally it gels. In this phase separation and gelling, the water-soluble polymer is in a dispersed state and precipitation thereof substantially does not occur.

As specific examples of the thermolytic compound which coexists at first, urea, or organic amides such as hexamethylene tetramine, formamide, N-methylformamide, and N,N-dimethyl acetoamide, can be used, but because the pH value of the solvent after heating is an important condition, there is no restriction in particular as long as it is a compound that makes the solvent alkaline after thermolysis.

The quantity of the thermolytic compound made to coexist differs according to the type of compound, but for example in the case of urea, it is 0.05-0.8 g, preferably 0.1-0.7 g, per 10 g reaction solution. Also, the temperature of heating, for example in the case of urea, is 40-200° C., and the pH value of the solvent after heating is preferably 6.0-12.0. Also, one which produces a compound having the property of dissolving silica by thermolysis such as hydrofluoric acid likewise can be used.

In the present invention, when the water-soluble polymer is dissolved in the acidic aqueous solution, and a metal compound having a hydrolytic functional group is added to that and a hydrolysis reaction is performed, a gel separated into a solvent rich phase and a skeletal phase is formed in the grooves. After the product (gel) has hardened, and after undergoing a suitable time for curing, by heating the wet gel, an amide series compound which was dissolved in advance in the reaction solution is thermally dissolved, and the pH of the solvent which is in contact with the inner wall surface of the skeletal phase rises. Also, the solvent erodes the inner wall surface, and gradually enlarges the size of the micropores by changing the corrugated state of the inner wall surface.

In the case of a gel having silica as the main constituent, the condition of change is very slight in the acidic or neutral region, but as the thermolysis becomes vigorous and the alkalinity of the aqueous solution increases, a reaction in which the parts constituting the micropores are dissolved and they are re-deposited on the flatter parts, whereby the average micropore size becomes greater, comes to occur prominently.

In a gel that does not have large pores and has only three-dimensionally confined bimodal pore, because the eluted substances can not be diffused as far as the external solution even in the parts that can be dissolved as the equilibrium state, a considerable proportion of the original microporous structure remains. As opposed to this, in a gel that has a solvent rich phase which becomes largely porous, because there are many micropores that are confined in two dimensions, and the exchange of substances with the external solution occurs with sufficient complexity, the small micropores are eliminated in parallel with the development of the large micropores, and there is no prominent spreading of the overall distribution of the micropore size.

In the heating process, it is effective to first put the gel into a sealed condition such that the vapor pressure of the thermolytic product is saturated and the pH of the solvent rapidly achieves a constant value.

Because the heat treatment time, which is required in order to achieve a state in which the dissolution and re-deposition reaction is constant and to obtain a monolithic bimodal pore structure corresponding to this, changes according to the size of the large pores and the volume of the test sample, it is necessary to determine the shortest treatment time in which the microporous structure substantially no longer changes in the various treatment conditions.

By gasifying the solvent, the gel having finished the heat treatment becomes a dry gel closely adhered to the channel walls in the grooves. Because there is the possibility that the coexisting substances in the departing solution may remain in this dry gel, the intended organic polyporous body can be obtained by performing the heat treatment at a suitable temperature and thermolyzing the organic substances, and the like. The drying is performed by setting aside at 30-80° C. for several hours to several tens of hours, and the heat treatment is to heat at about 200-800° C.

As for the plate member, all kinds of glass, quartz, Si substrates, plastics, and semiconductor substrates can be used, and the thickness thereof is preferably about 0.2-5 mm, for example. On this plate member, grooves (channels or reservoirs) are formed, for example by photofabrication technology, micromachining technology, laser processing technology, and the like. Here, photofabrication technology means a technology which creates a copy by transferring a pattern of a photomask, and generally, a photosensitive material called a photoresist or resist is applied to the substrate surface via a metal mask, and the pattern is transferred by light. Also, it is processed to a somewhat three-dimensional shape by etching, and the like, from the transferred planar pattern.

As for the photoresist (or resist) used, for example, OFPR 5000 manufactured by Tokyo Oka Company, Microposit S1400 and OMR 80-100cp manufactured by Sibley Far East Company can be used, but it is not limited to these, and it is not limited as long as it is one which can withstand the later etching process.

For transferring of the mask pattern, an adhesion exposure in which a photomask is adhered to the substrate which was applied with the resist, and a projection exposure which uses a stepper (reduction projection exposure apparatus), can be used, as in the case of ordinary integrated circuits. Also, it may be a holographic exposure. As the light source used during exposure, for example, a g radiation (436 nm) of an ultra-high-pressure mercury lamp can be used, and the exposure condition depends on the resist material and the thickness of the resist. When the mask pattern is transferred and metal is exposed, patterning of the metal mask is accomplished, and the substrate surface is brought out. Patterning of the metal mask, for example in the case of using gold as metal, is performed by using aqua regia.

As for the etching method, in the case of etching all kinds of glass and quartz, wet etching can be mentioned. The etchant for that is not limited in particular as long as it is a solution by which all kinds of glass and quartz are etched, but for example, the use of fluoric acid solution is common. Also, as the method of etching Si substrates, wet etching (anisotropic etching) can be mentioned. The etchant used for anisotropic etching is not particularly limited as long as it is an etchant that is used in this field, such as KOH aqueous solution, TMAH (tetramethyl ammonium hydride, and hydrazine.

The number of grooves is not particularly limited, but a plurality of grooves is formed, and it is preferable that silica gel having a dual microporous structure be formed in at least one of those grooves. Here, the dual microporous means, for example, a structure having micropores (through-pores) of 0.5-10 μm size, and micropores (mesopores) of 2-50 nm size. A multi-channel analysis chip can be fabricated by forming the same structured silica gel for a plurality of grooves.

Also, a part of the plurality of grooves may be used as preprocessing channels. In this case, in the preprocessing channels, preprocessing can be performed by filling silica gel having dual microporous structure or, for example, electrophoresis or gel filtration filler. Accordingly, the present invention provides a chromatographic chip, which is made by connecting a preprocessing channel which has a preprocessing part for refining samples on a plate member, and an analysis channel which is made by forming silica gel having dual microporous structure on the downstream side of that preprocessing channel

Here, the inner diameter of the analysis channel is 5-300 μm, preferably 10-100 μm, and the inner diameter of the preprocessing channel is 5-500 μm, preferably 50-300 μm. Furthermore, the analysis channel may be chemically modified with a silicificating agent. As silicificating agents, for example, octadecylsilylating agents, trimethylsilylating agents, and aminopropyl trimethoxysilane are preferable. As an octadecylsilylating agent, for example, octadecyldimethyl-N,N-diethylaminosilane, can be used, and as a trimethylsilylating agent, for example, 1,1,1,3,3,3-hexamethylsilane can be used. Also, it may be chemically modified with an ion exchange substance.

The plate member may be used as a single plate, and it may be used by affixing together with another plate such that the grooves face inward. In the case of one plate, the channels become an open system. In the case of affixing together two plate members, for example, tapered through-holes are formed on one of the plate members. Affixing together is performed by overlaying with the grooves facing inward. The means for affixing together (bonding) two plate members is not particularly limited, but it is desirable not to use an adhesive, but to directly bond the plate members to each other. For bonding of the columns with each other, means in which two plates of glass are fused by heating to about 600-1000° C. in a vacuum or in a nitrogen substituted atmosphere is desirable.

Also, for bonding of quartz, for example, a method in which glass is sputtered into a film on at least one substrate bonding surface and then it is heated in the same manner as above, is desirable. Furthermore, in the case of bonding glass and silicon, for example, an electrode bonding method in which they are heated to about 400° C. and negative voltage of about −1 kV is applied to the glass side may be used.

Further, in the present invention, a plurality of the chips for chromatograph may be laminated together. In case of lamination, analyzing flow path in one chip and a flow path of the chip to be laminated are connected for fluid communication to thereby analyze continuously. However, these chips may be used separably.

Furthermore, in the present invention, for detection of the separated sample, for example, a method in which light from a light source is injected into the analysis channel and absorption of the light in the analysis channel is detected with a detector, and a method in which electrodes are inserted into the channel and the amount of electrochemical change is measured, and the like, can be used, but it is not limited to these. As the light source, a light source in the ultraviolet/visible region, for example, He—Cd semiconductor laser, light emitting diode, heavy hydrogen lamp, or tungsten lamp can be used, and these lights may be led through optical fiber. Also, as the detector, for example, a photoelectronic multiplier tube, PIN diode, CCD camera, or the like, can be used, but it is not limited to these.

### BRIEF DESCRIPTION OF THE DRAWINGS

FIG. 1 is a plan view of one example of the chromatographic chip of the present invention; and

FIG. 2 is an explanatory perspective view of another example, in which the chromatographic chip of the present invention is layered and used as a proteome analysis chip.

### DETAILED DESCRIPTION OF PREFERRED EMBODIMENTS

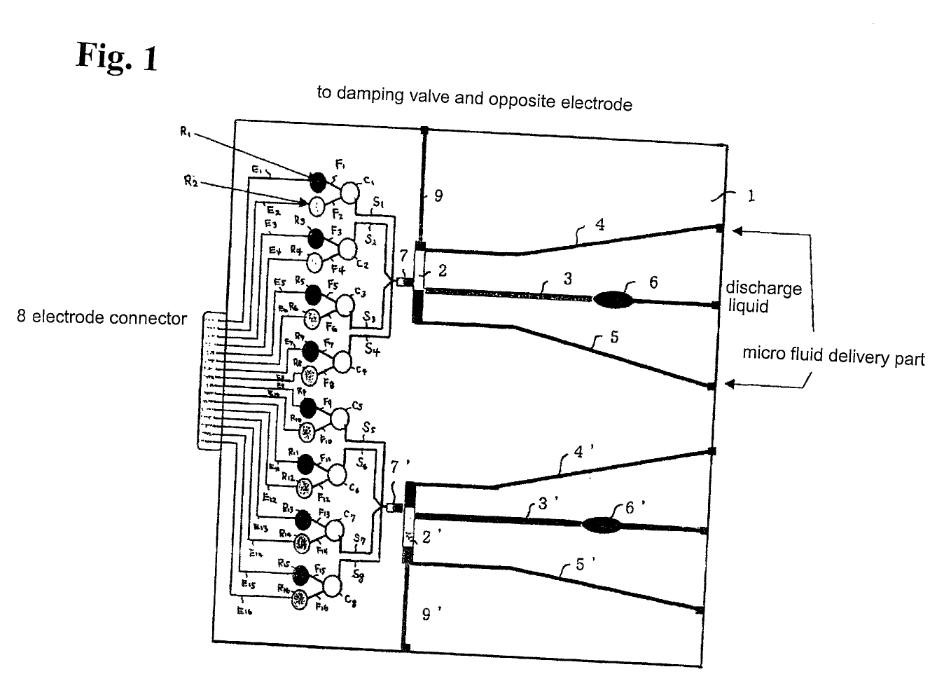

FIG. 1 shows a plan view of a chromatographic chip of the present invention. The chromatographic chip 1 is formed by affixing together a pair of transparent plate members, for example glass, of 20 mm vertically, 20 mm horizontally, and 0.5 mm thick.

On the surface of the lower plate member, analysis channels 3, 3′ formed of grooves, for example 100 μm wide and 10 μm deep, are formed by photofabrication technology. Detection parts 6, 6′ are formed inside the analysis channels 3, 3′, and these detection parts have enlarged width, for example 150 μm. Inside the detection parts 6, 6′, although not illustrated, a light source and detector are disposed so as to sandwich the plate member.

Also, on one end of the analysis channels 3, 3′, sample introduction channels 2, 2′ formed of grooves, for example 10 μm wide and 10 μm deep, are formed, and mobile phase channels 4, 4′, 5, 5′ formed of grooves, for example 10 μm wide and 10 μm deep, are connected to the sample introduction channels 2, 2′. Also, although it is not illustrated, on the ends of the mobile phase channels 4, 4′, 5, 5′, micro fluid delivery parts, for example formed of a syringe pump system, are connected.

Also, preprocessing channels S1-S8 are formed and connected to the sample introduction channels 2, 2′ by way of valve channels 7, 7′, and the preprocessing channels S1-S8 are formed of grooves, for example 200 μm wide and 10 μm deep. Furthermore, the preprocessing channels S1-S8 each branch out in two directions from confluence parts C1-C8 and form channels F1-F16. These channels F1-F16 preferably have the same width and depth as the preprocessing channels S1-S8.

Furthermore, on one end of the channels F1-F16, solution reservoir grooves R1-R16 (500 μm wide, 300 μm deep) are formed, and, for example, the odd-numbered grooves of the grooves R1-Rl6 are used as test sample reservoirs, and the even-numbered grooves are used as buffer solution reservoirs. Also, electrode patterns E1-E16, for example formed of aluminum wiring patterns, are connected to the grooves R1-R16, and an electrode connector 8 is connected to the electrode patterns E1-E16. By the electrode connector 8, the 16 electrode patterns can be suitably switched and applied with voltage. The opposite electrode to the electrode connector 8 is placed by embedding and connecting electrical lead wires 9, 9′ in the sample introduction channels 2, 2′.

On the upper plate member, through-holes are provided in positions corresponding to the grooves R1-R16 and in positions corresponding to the valve channels 7, 7′, wherein the test sample or the buffer solution is introduced from the through-holes in the positions corresponding to the grooves R1-R16, and fluid switching members are inserted into the through-holes in the positions corresponding to the valve channels 7, 7′. For the fluid switching member, for example, one which has holes in four directions on a rod-shaped tip can be used.

When using the above chromatographic chip 1, first, the analysis channels 3, 3′ are separated from the preprocessing channels S1-S8 by the members in the valve channels 7, 7′, and silica gel having a dual microporous structure is formed inside the analysis channels 3, 3′. The formation of the silica gel is performed, for example, in the following manner.

First, 0.90 g polyethylene oxide (manufactured by Aldrich, product number 85, 645-2), which is a water-soluble polymer, and 0.90 g urea were dissolved in log 0.01 normal acetic acid aqueous solution, 4 ml tetramethoxysilane was added to this solution while stirring, and a hydrolysis reaction was performed. After stirring for several minutes, the obtained transparent solution was introduced into the analysis channels 3, 3′, and it was kept in a 40° C. constant temperature bath, upon which it hardened after about 30 minutes.

The hardened test sample was heat cured for several more minutes, and it was kept for one hour at 120° C. in a sealed condition. At this time, the pH value of the solution coexisting with the gel was about 10.7. After this processing, the gel was dried for three days at 40° C., and it was heated to 400° C. at a rate of temperature increase of 100° C./h. By this, a polyporous body formed of amorphous silica was obtained in the analysis channels 3, 3′.

Next, the test sample is inserted into the grooves R1, 3, 5, 7, 9, 11, 13, 15 by micro syringe, and the like, and the buffer solution is inserted into the grooves R2, R4, R6, R8, R10, R12, R14, R16. The buffer solution is introduced up to the channels F2, F4, F6, F8, F10, F12, F14, the preprocessing channels S1-8, the valve channels 7, 7′, and the sample introduction channels 2, 2′.

First, voltage is applied such that the grooves R1, R3, R5, R7, R9, R11, R13, R15 and the sample introduction channels 2, 2′ conduct through each other, and as the test sample comes to the confluence parts C1-C8, the connection of the electrode connector is switched, and the voltage is sequentially applied to the grooves R1, R3, R5, R7, R9, R11, R13, R15. Doing thus, as the test sample sequentially enters the preprocessing channels 2, 2′, the mobile phase is delivered from the mobile phase channels 4 and 5, and 4′ and 5′, the test sample is introduced into the analysis channels 3, 3′, and chromatographic analysis is performed. The separated test sample is detected by the detectors 6, 6′.

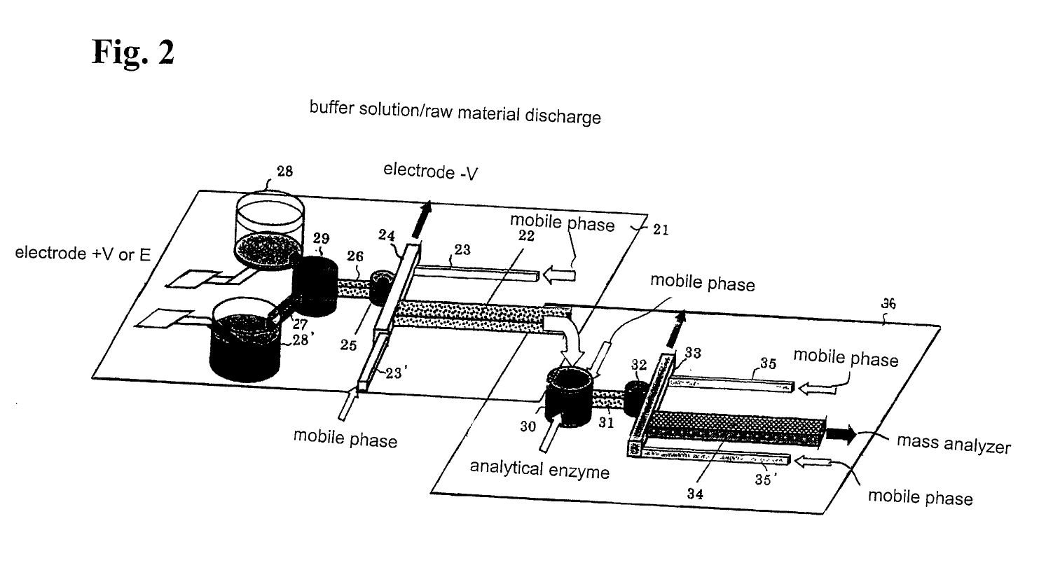

In the above chip, the analysis channels 3, 3′ may be chemically modified with the same silica agent, and it may be used as a so-called separate column by modifying with different silica agents. Also, the present invention is not limited to the above configuration, for example, it also may be the configuration in FIG. 2.

This configuration is one in which a plurality of chromatographic chips is layered, and the chips are formed by affixing together a pair of plate members in the same manner as in FIG. 1 described previously. A former stage chip 21 is roughly the same as the structure in FIG. 1, and an analysis channel 22, mobile phase channels 23, 23′, a sample introduction channel 24, a valve channel 25, a preprocessing channel 26, a confluence part 29, a channel 27, and grooves 28, 28′ are formed on the surface of the lower plate member of the pair of the plate members. On the upper plate member, through-holes are provided in the positions corresponding to the grooves 28, 28′ and the position corresponding to the valve channel 25. Also, the fact that an electrode pattern is formed so as to connect with the grooves 28, 28′ and an electrical lead is embedded to connect with the sample introduction channel 24, is the same as in FIG. 1. Furthermore, on the downstream side of the analysis channel 22, a through-hole is opened on the lower plate member, and the eluate in the analysis channel 22 flows out from the chip 21.

The latter stage chip 36 is formed by affixing together a pair of plate members in the same manner as the chip 21, and an analysis channel 24, mobile phase channels 35, 35′, a sample introduction channel 33, a valve channel 32, a preprocessing channel 31, and a groove 30 are formed on the surface of the lower plate member of the pair of plate members. On the upper plate member, through-holes are provided in the position corresponding to the groove 30 and in the position corresponding to the valve channel 32. Also, although it is not illustrated, a separate mobile phase channel is connected to the groove 30, so as to lead the test sample which has entered into the groove 30 by the mobile phase to the sample introduction channel 33.

With the above device, a proteome analysis chip can be formed, for example, by inserting a protein analysis enzyme into the groove 30, modifying the inside of the analysis channel 22 with an ion exchange substance, and modifying the analysis channel 34 with an octadecyl group.

With the proteome analysis chip, just as in FIG. 1, first, the buffer solution is inserted into the channel 27, the confluence part 29, the preprocessing channel 26, and the sample introduction channel 24 from the groove 28′ by micro syringe, and the like, and after putting it into an electrically conductive state, the test sample is inserted into the groove 28. Voltage is applied between the groove 28 and the sample introduction channel and after the test sample is led up to the confluence part 29, the electrodes are switched, and the voltage is applied between the groove 28′ and the sample introduction channel. The test sample which was led to the confluence part 29 moves to the preprocessing channel 26 and the sample introduction channel. By this electrophoresis, protein in the test sample can be separated out.

When the test sample enters into the sample introduction channel 24, the mobile phase is introduced into the mobile phase channels 23, 23′ by micro syringe, not illustrated, and the test sample is led to the analysis channel 22. In the analysis channel 22, refining of the protein in the test sample is performed, the refined protein enters into the groove 30 in which the protein analysis enzyme was inserted, and the protein is decomposed by the enzyme. The decomposed protein fragments are introduced into the sample introduction channel 33 by the mobile phase from the mobile phase channel not illustrated. When it enters into the sample introduction channel 33, the mobile phase is introduced into the mobile phase channels 35, 35′ by micro syringe, not illustrated, the test sample is led to the analysis channel 34, and the protein fragments are separated. The eluate from the analysis channel 34 is measured, for example, with a mass analyzer.

Also, the present invention is not limited to the chips in FIGS. 1 and 2 above, and it may be one in which a plurality of only the analysis channels shown in FIG. 1 is formed on the plate member, and furthermore, it also may be used as a fractionation chromatograph by placing a fractionation vessel at the ends of a plurality of analysis channels.

According to the present invention, because a unified (monolithic) polyporous body is synthesized by liquid phase reaction inside the grooves on the chip, the chromatographic chip having high reproducibility, low fluid resistance, and high separation performance can be fabricated. Also, not only channels (grooves) for separation, but also grooves for preprocessing can be formed on the chip, and preprocessing and separation can be realized on one chip.

While the invention has been explained with reference to the specific embodiments of the invention, the explanation is illustrative and the invention is limited only by the appended claims.

What is claimed is:

1. A chromatographic chip, comprising:
a plate member,
a plurality of grooves formed on the plate member, and
silica gel having monolithic bimodal pore structure formed in at least one of the grooves.

2. A chromatographic chip according to claim 1, wherein said plate member includes a sample preparation channel having a preprocessing part for refining samples, and an analysis channel communicating with the processing channel at a downstream side of the processing channel, said analysis channel having said silica gel with the monolithic bimodal pore structure.

3. A chromatographic chip according to claim 2, wherein said plate member includes a plurality of sections separated from each other and containing said preprocessing channel and said analysis channel.

4. A chromatographic chip according to claim 1, further comprising another plate member laminated over the plate member to form the grooves therebetween.

5. A chromatographic chip according to claim 1, wherein said dual microporous structure includes through pores and mesopores smaller than those of the through pores.

6. A chromatographic chip according to claim 5, wherein said through pores have a size of 5-10 μm, and the mesopores have a size of 2-50 nm.

7. A chromatographic chip assembly comprising a plurality of the chips according to claim 2, said chips communicating with each other to transfer liquid therethrough.

8. A method of fabrication of a chromatographic chip, comprising:
forming grooves on a plate member,
preparing a gel having a solvent rich phase which is rich in solvent and is continuous in a three-dimensional network form, and a skeletal phase which is rich in an inorganic substance and has micropores on a surface,
applying the gel inside the grooves, and
drying and heating the gel.

9. A method of fabrication according to claim 8, wherein the gel is prepared by a sol-gel method using phase separation in the grooves.
